(19) United States
(12) Patent Application Publication
(10) Pub. No.: US 2025/0306816 A1
(43) Pub. Date: Oct. 2, 2025

(54) INFORMATION PROCESSING APPARATUS, CONTROL METHOD, AND NON-TRANSITORY COMPUTER READABLE STORAGE MEDIUM

(71) Applicant: CANON KABUSHIKI KAISHA, Tokyo (JP)

(72) Inventor: TAKUYA INOUE, Ibaraki (JP)

(21) Appl. No.: 19/088,151

(22) Filed: Mar. 24, 2025

(30) Foreign Application Priority Data
Mar. 27, 2024 (JP) 2024-051065

(51) Int. Cl. G06F 3/12

(52) U.S. Cl. CPC G06F 3/121; G06F 3/1234

(57) ABSTRACT

An information processing apparatus with a job execution function executes one or more jobs, accepts selection of troubleshooting information, displays job information about one or more executed jobs in a display section of the information processing apparatus, accepts selection of one or more pieces of job information from the displayed job information, performs troubleshooting on the information processing apparatus based on the selected troubleshooting information and the selected job information, and displays a result of the troubleshooting in the display section.

### BACKGROUND

### Field of the Disclosure

The present disclosure relates to accurate troubleshooting conducted by an information processing apparatus.

### Description of the Related Art

When a job is executed using an information processing apparatus, such as a multi-function peripheral (MFP), errors may occur. For example, in a case where an MFP is used, an error may occur during printing, or although a print job is performed normally, the output material may not be as expected. There may be a case where a printing issue occurs as described above. In this case, a user checks a product manual and troubleshooting to resolve the issue. Further, if the user cannot reach a solution to the issue independently, the user may contact a call center or call a service engineer to resolve the issue.

While contacting the call center or calling the service engineer as described above, the user cannot operate the information processing apparatus, such as an MFP, as usual. Thus, the user is expected to resolve the issue independently to minimize the period during which the apparatus cannot operate normally.

Thus, technologies for presenting a solution candidate based on the state of an apparatus to enable the apparatus to operate normally are discussed, such as a technology discussed in Japanese Patent Application Laid-Open No. 2012-163805.

In order to minimize the period during which the information processing apparatus cannot operate normally as described above, it is proposed to equip the information processing apparatus with a troubleshooting function.

In a case where the user uses the troubleshooting function of the information processing apparatus, a job performed by the information processing apparatus is considered to prompt the user to use the troubleshooting function. However, the troubleshooting function of the information processing apparatus performs troubleshooting based on the current state of the information processing apparatus. Thus, a presented solution may not be an effective solution.

### SUMMARY

According to embodiments of the present disclosure, an information processing apparatus with a job execution function executes one or more jobs, accepts selection of troubleshooting information, displays job information about one or more executed jobs in a display section of the information processing apparatus, accepts selection of one or more pieces of job information from the displayed job information, performs troubleshooting on the information processing apparatus based on the selected troubleshooting information and the selected job information, and displays a result of the troubleshooting in the display section.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an image forming apparatus according to a first embodiment.

FIG. 2 is a diagram illustrating an example of a software configuration of the image forming apparatus.

FIG. 3 is a flowchart illustrating a process of storing job information in a job log during printing.

FIG. 4 is a diagram illustrating an example of a job log.

FIG. 5 is a diagram illustrating an example of a top menu screen for troubleshooting a job.

FIG. 6 is a diagram illustrating an example of a screen displaying candidate jobs related to a printing issue.

FIG. 7 is a flowchart illustrating a process of displaying candidate jobs related to a printing issue.

FIG. 8 is a diagram illustrating a candidate job extraction table for extracting a candidate job related to a printing issue.

FIG. 9 is a flowchart illustrating a process of troubleshooting a selected job according to the first embodiment.

FIG. 10 is a diagram illustrating a list of solutions to printing issues.

FIG. 11 is a diagram illustrating an example of a screen displaying solution candidates and details of a selected solution according to the first embodiment.

FIG. 12 is a flowchart illustrating a process of troubleshooting a selected job according to a second embodiment.

FIG. 13 is a diagram illustrating an example of a screen displaying solution candidates and details of a selected solution according to the second embodiment.

FIG. 14 is a flowchart illustrating a process of troubleshooting a selected job according to a third embodiment.

FIG. 15 is a diagram illustrating an example of a screen displaying a job history.

FIG. 16 is a diagram illustrating a list of solutions to printing issues.

FIG. 17 is a diagram illustrating an example of a screen displaying solution candidates and details of a selected solution according to a third embodiment.

FIG. 18 is a diagram illustrating an example of screen transitions in a case where after a job is selected, an issue is selected, and solutions are displayed according to the third embodiment.

FIG. 19 is a diagram illustrating an example of a screen transition in a case where solutions are displayed after a job is selected according to the third embodiment.

### DESCRIPTION OF THE EMBODIMENTS

Embodiments of the present disclosure will be described below with reference to the drawings.

A first embodiment will be described below with reference to the drawings. The first embodiment describes, as an example, an image forming apparatus configured to refine candidate solutions to a printing issue based on job log information about a job selected by a user and display only the candidates that may be related while hiding unrelated candidates.

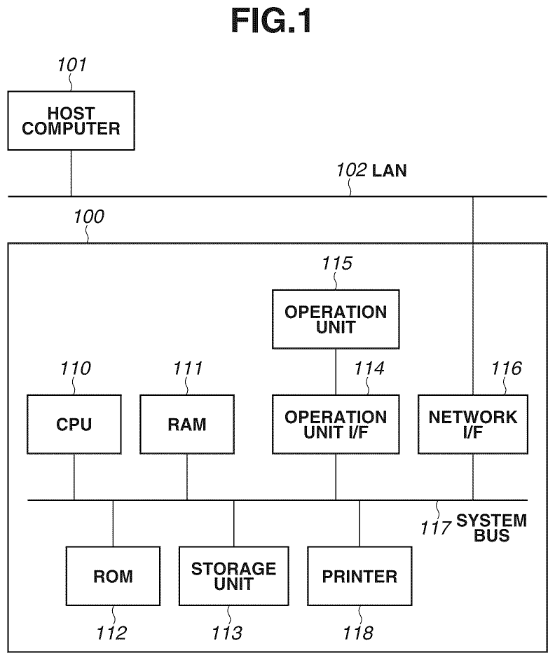

FIG. 1 is a diagram illustrating an example of a configuration of a printing system according to the present embodiment. In this system, a host computer 101 and an image forming apparatus 100 are connected via a local area network (LAN) 102. The user generates print data on the host computer 101 and transmits the generated print data from the host computer 101 to the image forming apparatus 100 via the LAN 102. The image forming apparatus 100 according to the present embodiment may be either a multi-function printer (MFP) or a single-function printer (SFP). MFP refers to a printer with a plurality of functions, such as fax, copy, print, and scan functions, while SFP refers to a printer with only a print function.

### <Hardware Configuration of Image Forming Apparatus>

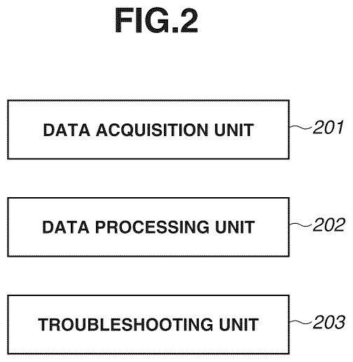

An example of a hardware configuration of the image forming apparatus 100 according to the first embodiment will be described below with reference to FIG. 1. A central processing unit (CPU) 110 is a central control unit of the image forming apparatus 100 and comprehensively controls each device connected to a system bus 117. A random access memory (RAM) 111 is a storage device accessible by the CPU 110. In the present embodiment, the RAM 111 is used as working memory for the CPU 110 to perform operations. A read-only memory (ROM) 112 stores a program, and the CPU 110 loads the program into the RAM 111 and executes the loaded program to cause each software module illustrated in FIG. 2 described below to operate. A storage unit 113 is, for example, a hard disk drive and stores system software for various processes and acquired print data. An operation unit interface (operation unit I/F) 114 is an interface unit for an operation unit 115 and outputs operation screen data to the operation unit 115. The operation unit 115 includes a display section for displaying information related to various menus and print data for which a print instruction has been issued. Further, the operation unit I/F 114 transmits information input by the user through the operation unit 115 to the CPU 110. A network interface (network I/F) 116 is an interface for communicating information with an external apparatus (e.g., the host computer 101) via the LAN 102. It should be noted that in the present embodiment, page description language (PDL) data is received as print data from the external apparatus. A printer 118 is a print engine that prints on a printing medium (such as a sheet) based on PDL data interpreted by the CPU 110.

It should be noted that the image forming apparatus 100 may include a reading device. The image forming apparatus 100 may be an apparatus that includes a so-called SEND function to scan an original and convert the scanned original into data using the reading device and transmit the data to the external apparatus.

FIG. 2 is a diagram illustrating an example of a software configuration of the image forming apparatus 100. The image forming apparatus 100 includes software modules 201, 202, and 203 illustrated in FIG. 2. The software modules 201, 202, and 203 are operated through the execution of the program loaded from the ROM 112 into the RAM 111 by the CPU 110 as described above. The data acquisition unit 201 receives PDL data. The data processing unit 202 interprets the received PDL data and performs a printing process. Further, the data processing unit 202 stores the PDL data information and the print result information in a job log. The troubleshooting unit 203 refines candidate solutions to an issue based on troubleshooting information and the job log and displays a candidate solution on the operation unit 115. Further, the troubleshooting unit 203 displays a solution on the operation unit 115 based on a selected candidate solution.

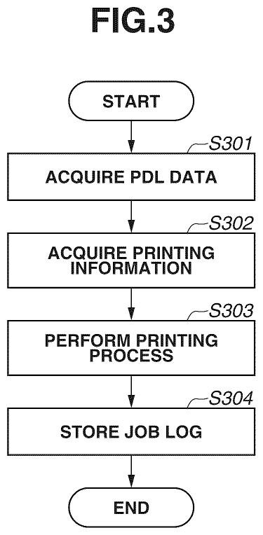

FIG. 3 is a flowchart illustrating a process flow of the acquisition of PDL data, the execution of the printing process, and the storage of a job log by the CPU 110.

In step S301, the data acquisition unit 201 in the CPU 110 communicates with, for example, the external apparatus via the network I/F 116 and receives PDL data. In another configuration, PDL data acquisition may be performed by retrieving PDL data stored in the storage unit 113 of the image forming apparatus 100.

In step S302, the data acquisition unit 201 acquires printing information. The printing information refers to information that relates to the acquired PDL data and is necessary for the PDL data printing process or to be stored in a job log. For example, information about an operating system (OS), a driver, and/or an application used to generate the PDL data, driver setting information such as paper size, paper type, and page layout, and main unit setting information, such as halftone and thickness adjustment, stored in the storage unit 113 of the image forming apparatus 100 are acquired. A conventional method is used to acquire printing information. While detailed descriptions are omitted, the PDL data is analyzed, and print settings associated with the PDL data are acquired.

As another option, print settings stored in the storage unit 113 of the image forming apparatus 100 can be acquired. Further, other methods for acquiring information about the OS and/or the application used to generate the PDL data include a method in which the information is associated with the PDL data and acquired from the PDL data and a method in which the information is acquired separately from the PDL data via the network I/F 116. In step S303, the data processing unit 202 in the CPU 110 performs the printing process.

In the case of printing PDL data stored in the storage unit 113 of the image forming apparatus 100, printing is initiated when the user presses a print execution button on the operation unit 115. Specifically, PDL job information stored in the storage unit 113 is displayed on the operation unit 115 (third display unit), and the user selects a PDL job to be printed and issues an instruction to execute printing.

In the printing process, first, the acquired PDL data is analyzed, and intermediate data is generated for the number of pages. Next, raster image processing (RIP) is performed based on the generated intermediate data, and an image formation process for conversion into a raster image is performed. Thereafter, the CPU 110 performs image processing on the raster image, and the printer 118 prints the rasterized image after image processing on a printing medium.

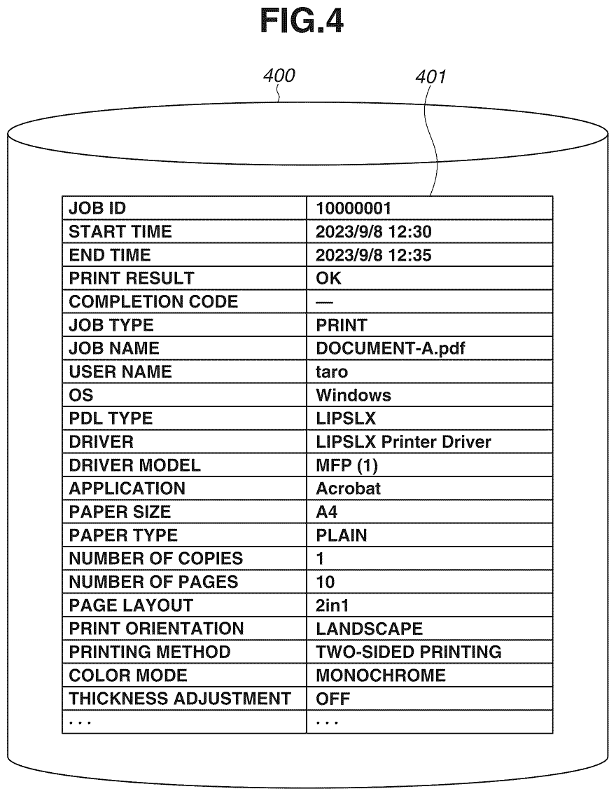

In step S304, the data processing unit 202 in the CPU 110 performs a job log storing process. In the job log storing process, information related to the PDL data on which the printing process has been performed is stored as a job log in the storage unit 113. The data processing unit 202 builds a job log database (job log DB) in the storage unit 113 and stores the generated job log together with previous job logs in the job log DB. FIG. 4 illustrates an example of a job log DB and a job log. In FIG. 4, a job log DB 400 is illustrated, and a job log 401 is illustrated as an example of a job log. The job log 401 stores information acquired before the initiation of the printing process and print results. Specific items of the job log 401 will be described below.

The “job ID” item specifies a unique value for job identification.

The “start time” item specifies the time when the printing process begun.

The “end time” item specifies the time when the printing process ended.

The “print result” item specifies a value indicating the result of the printing process, and the value is “OK” in a case where the printing process is finished normally, whereas the value is “NG” in a case where the printing process is finished abnormally.

The “completion code” item specifies an identification number for checking an error message in a case where the print result is “NG”. In a case where the print result is “OK”, the item specifies “ [symbol] ”.

The “job type” item specifies the type of the job, such as fax, copy, print, or scan. The “job name” item specifies the name of the printed file.

The “user name” item specifies the name of the user who has executed the printing.

The “OS” item specifies the OS, such as Windows or macOS®, of the terminal through which the user executed the printing.

The “PDL type” item specifies the type of the PDL data, such as Laser Beam Printer (LBP) Image Processing System LX (LIPSLX), Printer Command Language Extended (PCLXL), or Portable Document Format (PDF).

The “driver” item specifies the name of the driver used for the printing. In a case where the printing is direct printing without using a driver, the item specifies “ [symbol] ”.

The “driver model” item specifies the model applied to the driver used for the printing.

The “application” item specifies the name of the application that has executed the printing.

The “paper size” item specifies the paper size, such as A4, B4, or postcard.

The “paper type” item specifies the paper type, such as plain paper, thick paper, or envelope.

The “number of copies” item specifies the number of copies printed with the same content.

The “number of pages” item specifies the number of pages of the PDL data.

The “page layout” item specifies a setting such as N-in-1 printing.

The “print orientation” item specifies a portrait or landscape setting.

The “printing method” item specifies a one-sided or two-sided printing setting.

The “color mode” item specifies a color setting such as color, monochrome, or automatic.

The “thickness adjustment” item specifies a setting for thickening text, lines, or graphics.

The foregoing items stored in the job log are merely examples and are not limitations. In the job log DB 400, a job log is stored for each job and used in displaying a job history or troubleshooting a printing issue.

A troubleshooting unit of an information processing apparatus will be described below.

The user checks the result of a job performed by the information processing apparatus and performs troubleshooting to verify whether there is an issue with the information processing apparatus. Here, the information processing apparatus according to the present embodiment includes the troubleshooting unit, and the troubleshooting unit performs troubleshooting based on the job performed by the information processing apparatus. This makes it possible to provide the user with a more accurate troubleshooting result.

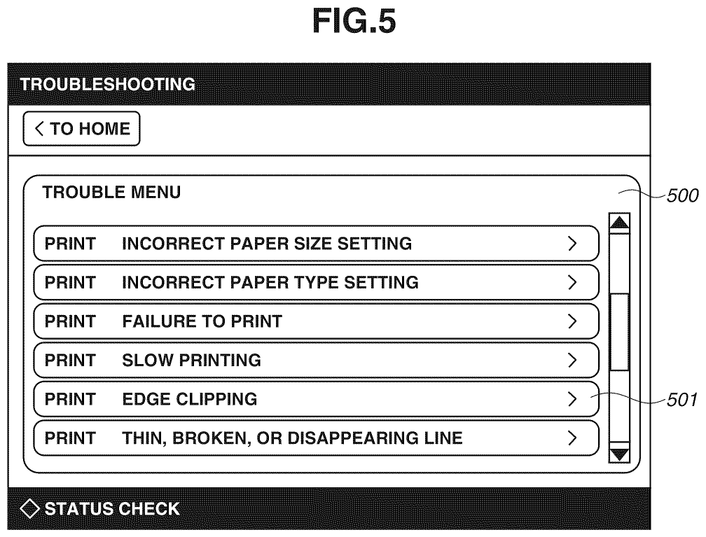

FIG. 5 is a diagram illustrating an example of a top menu for performing troubleshooting using the troubleshooting unit. A troubleshooting menu 500 displays troubleshooting information to be selected. In the troubleshooting menu 500, a troubleshooting menu button is displayed for each function and issue symptom, which is troubleshooting information.

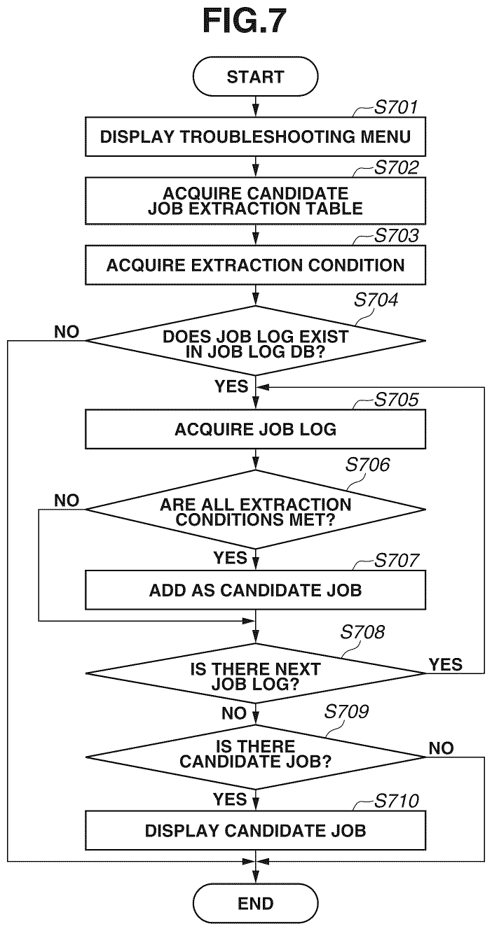

An example of the display of candidate jobs in a case where an “edge clipping” menu button 501 of the “print” function is pressed will be described below with reference to FIGS. 5 to 8. FIG. 7 is a flowchart illustrating a process flow of displaying candidate jobs performed by the CPU 110.

In step S701, the troubleshooting unit 203 in the CPU 110 displays the troubleshooting menu 500 illustrated in FIG. 5.

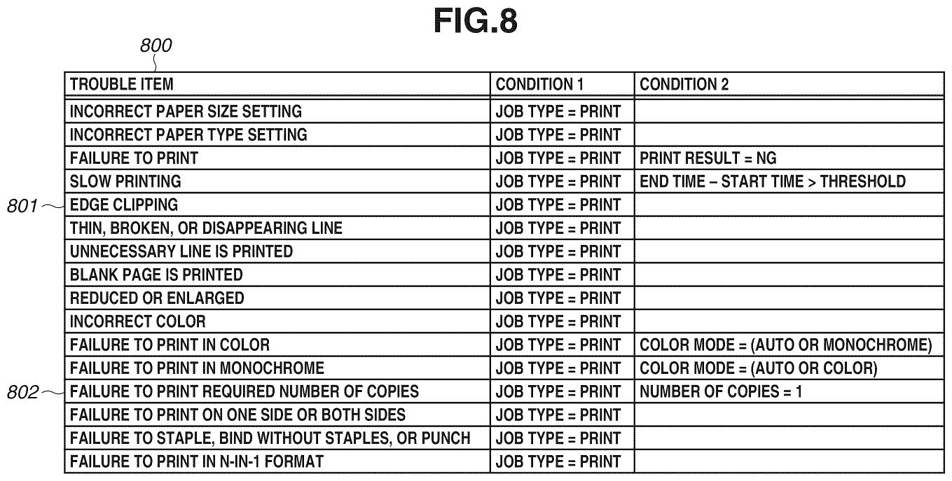

In step S702, the troubleshooting unit 203 acquires a candidate job extraction table 800 illustrated in FIG. 8. The troubleshooting unit 203 accepts the press of the “edge clipping” menu button 501, which is one of the troubleshooting information (first acceptance unit). Then, in step S703, the troubleshooting unit 203 acquires a candidate job extraction condition associated with “edge clipping” 801 from the candidate job extraction table 800. The candidate job extraction condition associated with the “edge clipping” 801 is a job with a job type value of “print”.

In step S704, the troubleshooting unit 203 verifies whether a job log exists in the job log DB 400. In a case where one or more job logs exist (YES in step S704), the processing proceeds to step S705. In a case where there is not even a single job log (NO in step S704), the process ends since there are no candidate jobs to display.

In step S705, the troubleshooting unit 203 acquires a single job log from the job log DB 400. In step S706, the troubleshooting unit 203 verifies whether the acquired job log meets all the extraction conditions. In a case where all the extraction conditions are met (YES in step S706), the processing proceeds to step S707. In a case where not all the extraction conditions are met (NO in step S706), the processing proceeds to step S708.

In step S707, in a case where all the extraction conditions are met, the troubleshooting unit 203 adds the corresponding job as a candidate job. For example, the candidate job extraction condition associated with the “edge clipping” 801 is a job with a job type value of “print”, and the job log 401 meets the condition. Therefore, the job log 401 is extracted as a candidate job.

In step S708, the troubleshooting unit 203 verifies whether there is a job log in the job log DB 400 that has not been compared with the extraction conditions. In a case where there is a job log that has not been compared with the extraction conditions (YES in step S708), the processing returns to step S705. Then, a new job log is acquired, and steps S706 and S707 are repeated. In a case where every job log has been compared with the extraction conditions (NO in step S708), the processing proceeds to step S709.

In step S709, the troubleshooting unit 203 verifies whether there is a candidate job that meets the conditions.

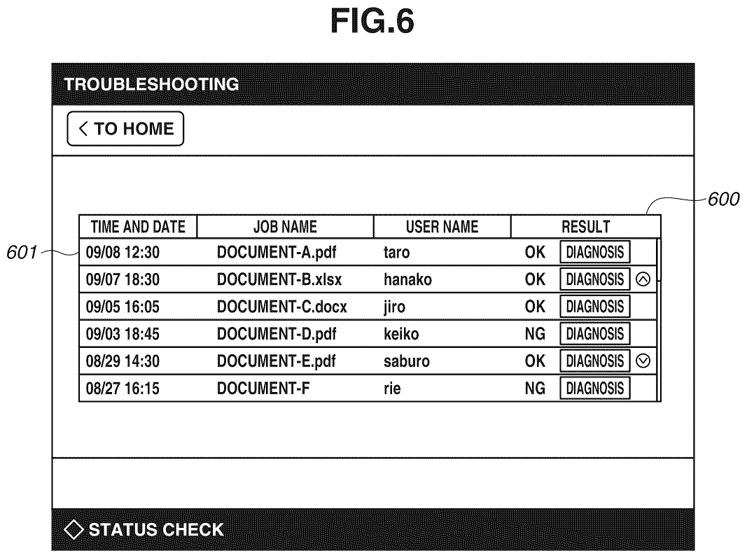

In a case where there is a candidate job (YES in step S709), the processing proceeds to step S710, and the candidate job is displayed in a candidate job display section (600) on the operation unit 115 illustrated in FIG. 6 (first display unit). The first display unit displays predetermined job information so that the user can distinguish the candidate job from other candidate jobs. In a case where there are no candidate jobs (NO in step S709), the process ends without performing the candidate job display by the first display unit since there are no candidate jobs to display.

While an example of candidate job extraction for the issue of “edge clipping” 801 is described, the same extraction method is applied to cases where other issues are selected. For example, in a case where an issue of “failure to print required number of copies” 802 is selected, extraction is performed based on the conditions associated with the issue 802. Every job with a job type value of “print” and a number of copies equal to “1” is extracted from the job log DB 400 and displayed.

As described above, candidate job extraction is performed based on the conditions specified in the candidate job extraction table 800 in FIG. 8. While the extraction method using the conditions associated with the issues is described above, candidate job extraction may be performed using an unassociated condition in combination (e.g., extract the 50 most recent jobs, extract a job from the log-in user). Further, the conditions associated with the issues are not limited to those described above.

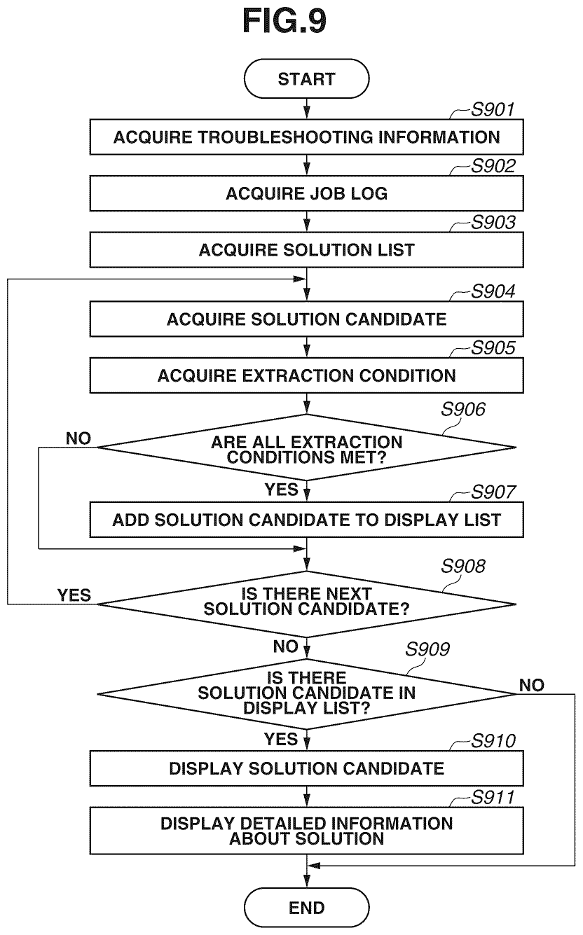

An example of troubleshooting solution display in a case where troubleshooting information of the “edge clipping” 501 and a job 601 are selected will be described below with reference to FIGS. 9 to 11.

FIG. 9 is a flowchart illustrating a flow of refining solution candidates for the issue by the troubleshooting unit 203 in the CPU 110 based on the selected troubleshooting information and the selected job information.

The troubleshooting unit 203 in the CPU 110 accepts the selection of the “edge clipping” 501 (first acceptance unit) and, furthermore, accepts the press of a diagnosis button for the job 601 (second acceptance unit). Then, in step S901, troubleshooting information is acquired. Here, the “edge clipping” issue is acquired as troubleshooting information.

Next, in step S902, the troubleshooting unit 203 acquires a job log corresponding to the selected job information. Here, the job log 401 corresponding to the job 601 is acquired.

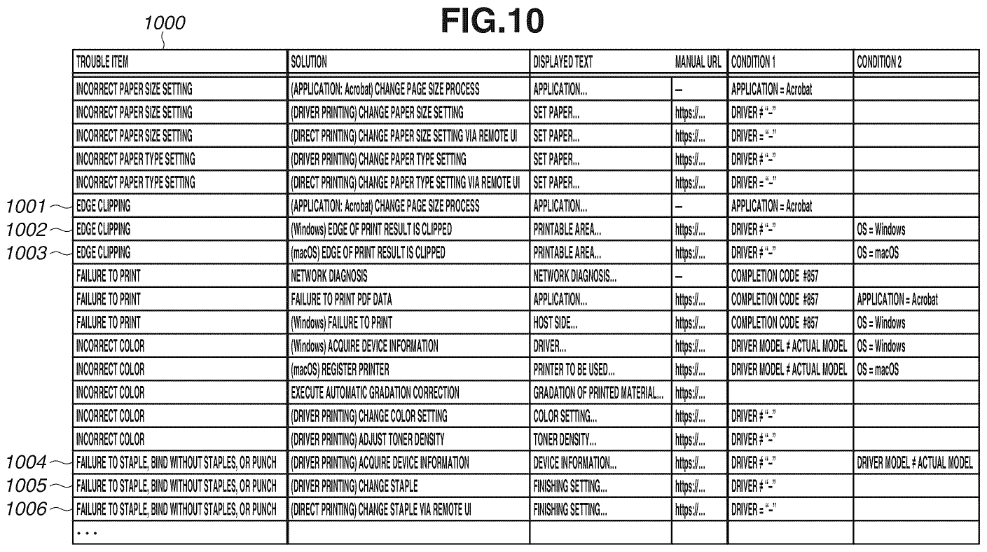

In step S903, the troubleshooting unit 203 acquires a solution list 1000 illustrated in FIG. 10. In step S904, the troubleshooting unit 203 acquires a single solution candidate from the solution list 1000. In step S905, the troubleshooting unit 203 acquires extraction conditions for determining whether the acquired solution candidate is to be extracted as a solution candidate.

In step S906, the troubleshooting unit 203 verifies whether the acquired job log 401 meets all the extraction conditions. In a case where all the extraction conditions are met (YES in step S906), the processing proceeds to step S907. Then, the troubleshooting unit 203 adds the solution candidate to a display list, and the processing proceeds to step S908. In a case where there is a condition that is not met (NO in step S906), the processing proceeds to step S908.

In step S908, the troubleshooting unit 203 verifies whether there is another solution candidate that has not been compared. In a case where there is another solution candidate that has not been compared (YES in step S908), the processing returns to step S904. Then, a new solution candidate is acquired, and steps S905 to S907 are repeated. In a case where there are no other solution candidates that have not been compared (NO in step S908), the processing proceeds to step S909.

In the case of the “edge clipping” issue, the corresponding solution candidates are solution candidates 1001 to 1003 in the solution list 1000. The job log 401 is compared with each of the extraction conditions associated with the solution candidates 1001 to 1003. The extraction condition associated with the “(application: Acrobat) change page size process” 1001 is application= “Acrobat”. In the job log 401, application= “Acrobat”. Since the condition is met, the corresponding solution candidate is added to the display list. The conditions associated with the “(Windows) edge of print result is clipped” 1002 are driver ≠“−” and OS=Windows. In the job log 401, driver= “LIPSLX Printer Driver” and OS= “Windows”. Since the conditions are met, the corresponding solution candidate is added to the display list. The conditions associated with the “(macOS) edge of print result is clipped” 1003 are driver ≠“−” and OS=macOS. In the job log 401, driver= “LIPSLX Printer Driver” and OS= “Windows”. Since there is a condition that is not met, the corresponding solution candidate is not added to the display list. At the end, the solution candidates 1001 and 1002 are added to the display list.

In step S909, the troubleshooting unit 203 verifies whether there is a solution candidate in the display list. In a case where there is a solution candidate (YES in step S909), the processing proceeds to step S910.

In step S910, the troubleshooting results are displayed as a result of troubleshooting performed by the troubleshooting unit (second display unit).

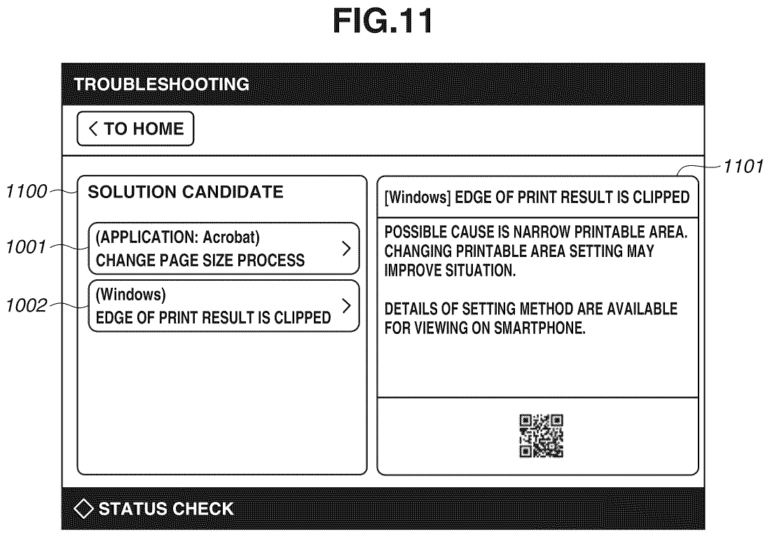

The second display unit displays the solution candidates as troubleshooting results in a candidate display section (1100) on the operation unit 115 illustrated in FIG. 11. For example, two solution candidates are displayed by the second display unit here. In a case where the press of a menu button for the “(Windows) edge of print result is clipped” 1002 is detected, in step S911, the troubleshooting unit 203 displays detailed information about the selected solution in a solution details display section (1101). Specifically, the displayed text associated with the “(Windows) edge of print result is clipped” 1002 in FIG. 10 and an image generated by converting a manual uniform resource locator (manual URL) into a quick response code (QR code®) are displayed. The displayed content is merely an example and not a limitation.

While an example of solution candidate extraction in a case where the “edge clipping” issue and the job 601 are selected is described, the same solution candidate extraction method applies to cases where a combination of another issue and another job is selected. For example, in a case where an issue of “failure to staple, bind without staples, or punch” and the job 601 are selected, extraction is performed by comparing with conditions associated with solution candidates 1004 to 1006 corresponding to “failure to staple, bind without staples, or punch”. The comparison is performed with information in the job log 401 corresponding to the job 601, and the solution candidate 1005 is eventually added to the display list and displayed (second display unit). As described above, in a case where the issue of “failure to staple, bind without staples, or punch” is selected, the solution candidate related to “failure to staple, bind without staples, or punch” and the selected job is displayed. This is clearly not a limitation, and in a case where the job used in troubleshooting by the troubleshooting unit is a SEND job, a solution candidate related to the SEND job is displayed.

As described above, in the present embodiment, solution candidates for a printing issue are refined based on job log information about a job selected by the user, and only the candidates that may be related are displayed while unrelated candidates are hidden.

This enables the user to promptly find an effective solution to the printing issue, whereas there have been instances where it takes time for the user to identify an effective solution from a plurality of solutions to the printing issue, or where the user cannot reach a solution to the issue independently.

A second embodiment will be described below with reference to the drawings. The second embodiment describes an example of a process of prioritizing solution candidates and displaying methods with a high likelihood of relevance at the top and unrelated methods at the bottom. It should be noted that an image forming apparatus according to the second embodiment has a configuration similar to the configuration according to the first embodiment illustrated in FIG. 1. Only the differences from the first embodiment will be described below.

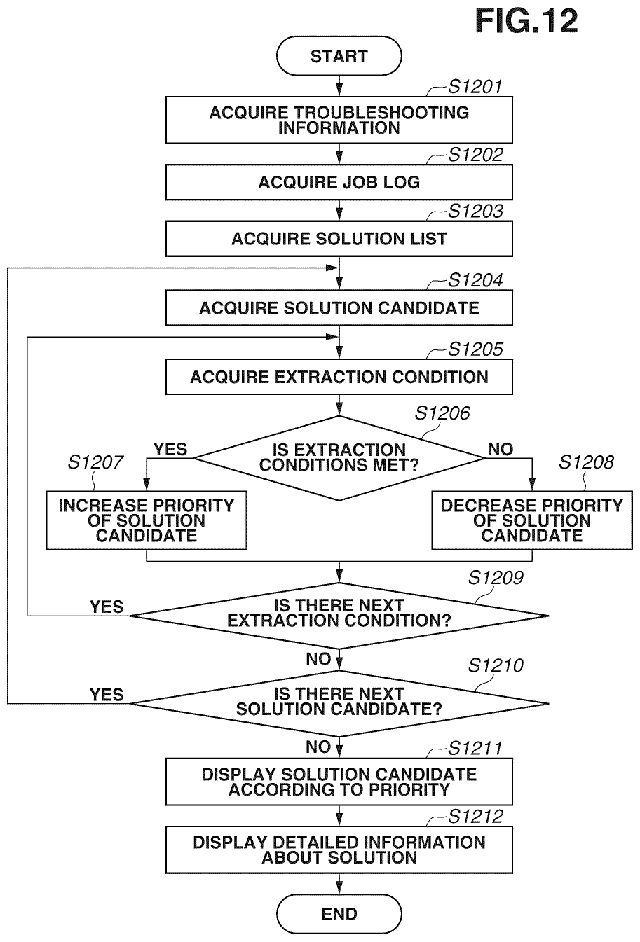

In the second embodiment, the troubleshooting unit 203 in the CPU 110 performs a process of prioritizing solution candidates for the issue and changing the display order of the solution candidates based on the selected troubleshooting information and the selected job. The process will be described below with reference to a flowchart illustrated in FIG. 12. An example of solution display in a case where troubleshooting information of the “edge clipping” 501 of the “print” function (first acceptance unit) and the job 601 (second acceptance unit) are selected and troubleshooting is performed will be described below.

In a case where the press of the diagnosis button for the job 601 is detected after the issue of “edge clipping” 501 is selected, first, in step S1201, the troubleshooting unit 203 in the CPU 110 acquires troubleshooting information. Here, the “edge clipping” issue is acquired as troubleshooting information.

Next, in step S1202, the troubleshooting unit 203 acquires a job log corresponding to the selected job. Here, the job log 401 corresponding to the job 601 is acquired.

In step S1203, the troubleshooting unit 203 acquires the solution list 1000 illustrated in FIG. 10. In step S1204, the troubleshooting unit 203 acquires a single solution candidate from the solution list 1000. In step S1205, the troubleshooting unit 203 acquires a single extraction condition for determining whether the acquired solution candidate should be extracted as a solution candidate.

In step S1206, the troubleshooting unit 203 verifies whether the acquired job log 401 meets the extraction condition. In a case where the extraction condition is met (YES in step S1206), the processing proceeds to step S1207. Then, the troubleshooting unit 203 increases the priority of the solution candidate, and the processing proceeds to step S1209. In a case where the extraction condition is not met (NO in step S1206), the processing proceeds to step S1208. Then, the troubleshooting unit 203 decreases the priority of the solution candidate, and the processing proceeds to step S1209.

In step S1209, the troubleshooting unit 203 verifies whether there is another extraction condition. In a case where there is another extraction condition (YES in step S1209), the processing returns to step S1205. Then, a new extraction condition is acquired, and steps S1206 to S1208 are repeated. In a case where there are no other extraction conditions (NO in step S1209), the processing proceeds to step S1210.

In step S1210, the troubleshooting unit 203 verifies whether there is another solution candidate that has not been compared. In a case where there is another solution candidate that has not been compared (YES in step S1210), the processing returns to step S1204. Then, a new solution candidate is acquired, and steps S1205 to S1209 are repeated. In a case where there are no other solution candidates that have not been compared (NO in step S1210), the processing proceeds to step S1211.

In the case of the “edge clipping” issue, the corresponding solution candidates are solution candidates 1001 to 1003 in the solution list 1000. The job log 401 is compared with each of the extraction conditions associated with the solution candidates 1001 to 1003, and the solution candidates 1001 to 1003 are prioritized. Here, a method for scoring solution candidates is introduced as an example of a prioritization method. One point is added each time the condition is met, and two points are subtracted each time the condition is not met. The “(application: Acrobat) change page size process” 1001 is associated with the condition that is application= “Acrobat”.

Since application= “Acrobat” in the job log 401, the condition is met, so that the score for the “(application: Acrobat) change page size process” 1001 is one point. The “(Windows) edge of print result is clipped” 1002 is associated with two conditions that are driver≠“−” and OS=Windows. Since driver= “LIPSLX Printer Driver” and OS= “Windows” in the job log 401, the conditions are met, so that the score for the “(Windows) edge of print result is clipped” 1002 is two points. The “(macOS) edge of print result is clipped” 1003 is associated with two conditions that are driver ≠“−” and OS=macOS. Since driver= “LIPSLX Printer Driver” in the job log 401, the condition is met, so that one point is added. However, since the condition that OS= “Windows” is not met, two points are subtracted. As a result, the score for the “(macOS) edge of print result is clipped” 1003 is minus one point. Consequently, the solution candidates 1001, 1002, and 1003 are scored one point, two points, and minus one point, respectively, and prioritized.

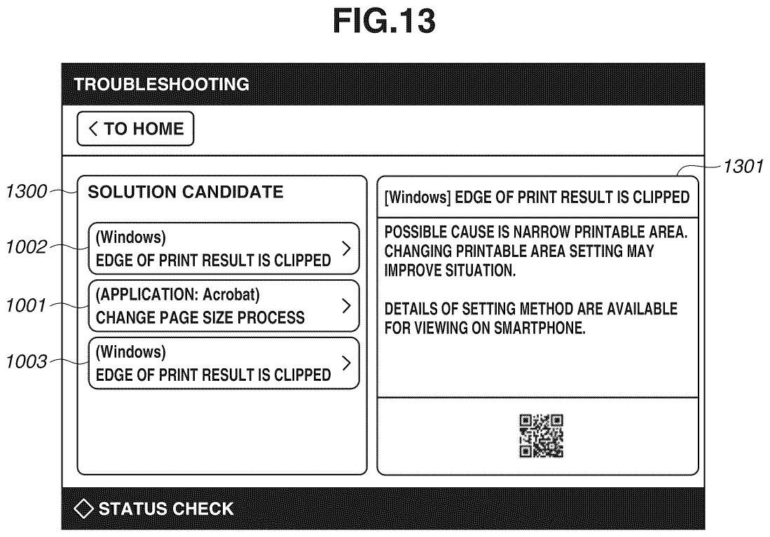

In step S1211, the troubleshooting unit 203 displays the prioritized solution candidates in descending order of scores in a candidate display section (1300) on the operation unit 115 illustrated in FIG. 13 (second display unit).

Here, the candidate solutions 1002, 1001, and 1003 are displayed in this order. In a case where the press of the menu button for the “(Windows) edge of print result is clipped” 1002 is detected, in step S1212, the troubleshooting unit 203 displays detailed information about the selected solution in a solution details display section (1301). Specifically, the displayed text associated with the “(Windows) edge of print result is clipped” 1002 in FIG. 10 and an image generated by converting a manual URL into a QR code are displayed. The displayed content is merely an example and not a limitation. The prioritization method is also a mere example and not a limitation. For example, another method in which the conditions are weighted and the highest priority is assigned in a case where the application matches may be used. The display order of solution candidates in the case of equal scores may be determined based on weights assigned in advance to the solutions, or the solution candidates may be displayed in the order in which they are found from the list. Further, a lower-ranked candidate may be grayed out when displayed to express its weak connection, or another method may be used.

As described above, in the present embodiment, the solution candidates for the printing issue are displayed so that solutions with a high likelihood of relevance are displayed at the top while unrelated candidates are displayed at the bottom based on job log information about the job selected by the user.

This enables the user to promptly find an effective solution to the printing issue, whereas there have been instances where it takes time for the user to identify an effective solution from a plurality of solutions to the printing issue, or where the user cannot reach a solution to the issue independently. Further, it also becomes possible to try the unrelated candidates in a case where the solutions with a high likelihood of relevance fail to resolve the issue.

A third embodiment will be described below with reference to the drawings. The third embodiment describes an example of an image forming apparatus that does not select troubleshooting information and performs troubleshooting based on a job selected from a job history. Solution candidates are refined based on job log information about the selected job, and only the candidates that may be related are displayed while unrelated candidates are hidden. It should be noted that the image forming apparatus according to the third embodiment has a configuration similar to the configuration according to the first embodiment illustrated in FIG. 1. Only the differences from the first embodiment will be described below.

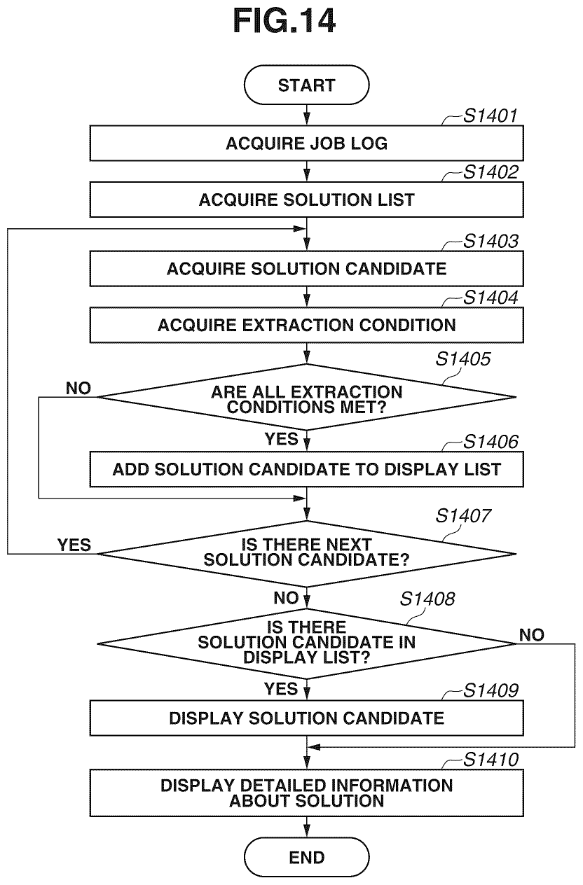

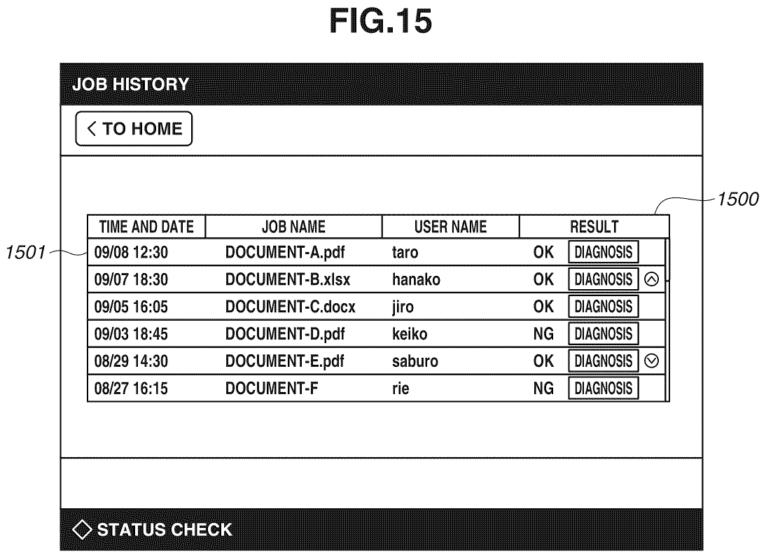

In the third embodiment, the troubleshooting unit 203 in the CPU 110 performs a process of refining solution candidates based on job log information about a selected job and displaying only the candidates that may be related. The process will be described below with reference to a flowchart illustrated in FIG. 14. FIG. 15 illustrates an example of a job history screen, and an example of solution display in a case where a job 1501 is selected (acceptance unit) from a job history 1500 (first display unit) and troubleshooting is performed without selecting an issue will be described below. In the third embodiment, the first display unit serves as a display unit configured to display job information.

In a case where the press of a diagnosis button for the job 1501 in the job history 1500 is detected (acceptance unit), first, in step S1401, the troubleshooting unit 203 in the CPU 110 acquires a job log corresponding to the selected job. Here, the job log 401 corresponding to the job 1501 is acquired.

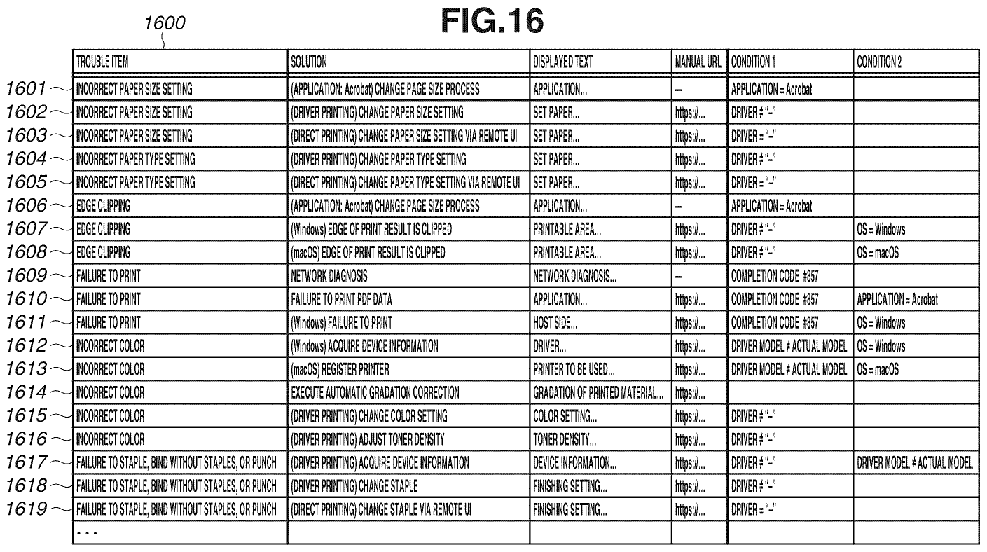

Next, in step S1402, the troubleshooting unit 203 acquires a solution list 1600 illustrated in FIG. 16. In step S1403, the troubleshooting unit 203 acquires a single solution candidate from the solution list 1600. In step S1404, the troubleshooting unit 203 acquires extraction conditions for determining whether the acquired solution candidate should be extracted as a solution candidate.

In step S1405, the troubleshooting unit 203 verifies whether the acquired job log 401 meets all the extraction conditions. In a case where all the extraction conditions are met (YES in step S1405), the processing proceeds to step S1406. Then, the troubleshooting unit 203 adds the solution candidate to the display list, and the processing proceeds to step S1407. In a case where there is a condition that is not met (NO in step S1405), the processing proceeds to step S1407.

In step S1407, the troubleshooting unit 203 verifies whether there is another solution candidate that has not been compared. In a case where there is another solution candidate that has not been compared (YES in step S1407), the processing returns to step S1403. Then, a new solution candidate is acquired, and steps S1404 to S1406 are repeated. In a case where there are no other solution candidates that have not been compared (NO in step S1407), the processing proceeds to step S1408.

Since only the job 1501 is selected from the job history 1500 and troubleshooting is performed without selecting troubleshooting information, all the solutions in the solution list 1600 serve as targets for condition comparison, and the job log 401 is compared with extraction conditions for all the solutions to refine the solution candidates. Here, an example of comparing the job log 401 with each of excerpted extraction conditions 1606 to 1608 will be described below. The extraction condition associated with the “(application: Acrobat) change page size process” 1606 is application=“Acrobat”. In the job log 401, application= “Acrobat”. Since the condition is met, the corresponding solution candidate is added to the display list. The conditions associated with the “(Windows) edge of print result is clipped” 1607 are driver ≠“−” and OS=Windows. In the job log 401, driver= “LIPSLX Printer Driver” and OS= “Windows”. Since the conditions are met, the corresponding solution candidate is added to the display list. The conditions associated with the “(macOS) edge of print result is clipped” 1608 are driver ≠“−” and OS=macOS. In the job log 401, driver= “LIPSLX Printer Driver” and OS= “Windows”. Since there is a condition that is not met, the corresponding solution candidate is not added to the display list. Similarly, the job log 401 is compared with all extraction conditions associated with the solutions 1601 to 1619, and the solution candidates 1601, 1602, 1604, 1606, 1607, 1614, 1615, 1616, and 1618 are consequently added to the display list.

In step S1408, the troubleshooting unit 203 verifies whether there is a solution candidate in the display list.

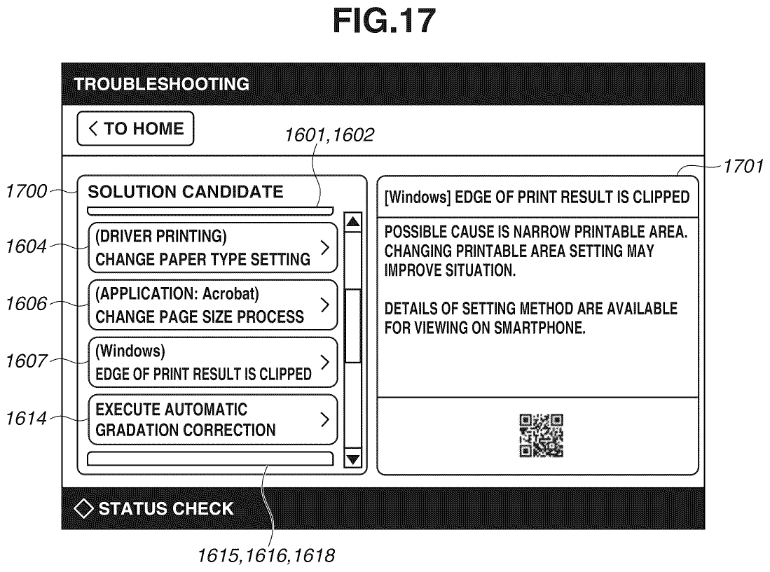

In a case where there is a solution candidate (YES in step S1408), in step S1409, the solution candidate is displayed in a candidate display section (1700) on the operation unit 115 illustrated in FIG. 17. Here, the solution candidates 1601, 1602, 1604, 1606, 1607, 1614, 1615, 1616, and 1618 are displayed. In a case where the solution candidates do not fit on the screen, only a portion is displayed, and the remaining candidates are available for viewing by scrolling. While scrolling is described as an example in the case where the solution candidates do not fit on the screen, this is not a limitation, and the solution candidates may be displayed by switching pages.

In a case where the press of a menu button for the “(Windows) edge of print result is clipped” 1607 is detected, in step S1410, the troubleshooting unit 203 displays detailed information about the selected solution in a solution details display section (1701). Specifically, the displayed text associated with the “(Windows) edge of print result is clipped” 1607 in FIG. 16 and an image generated by converting a manual URL into a QR code are displayed. The displayed content is merely an example and not a limitation.

While an example of solution candidate extraction in a case where the job 1501 is selected is described, the same solution candidate extraction method applies to cases where other jobs are selected.

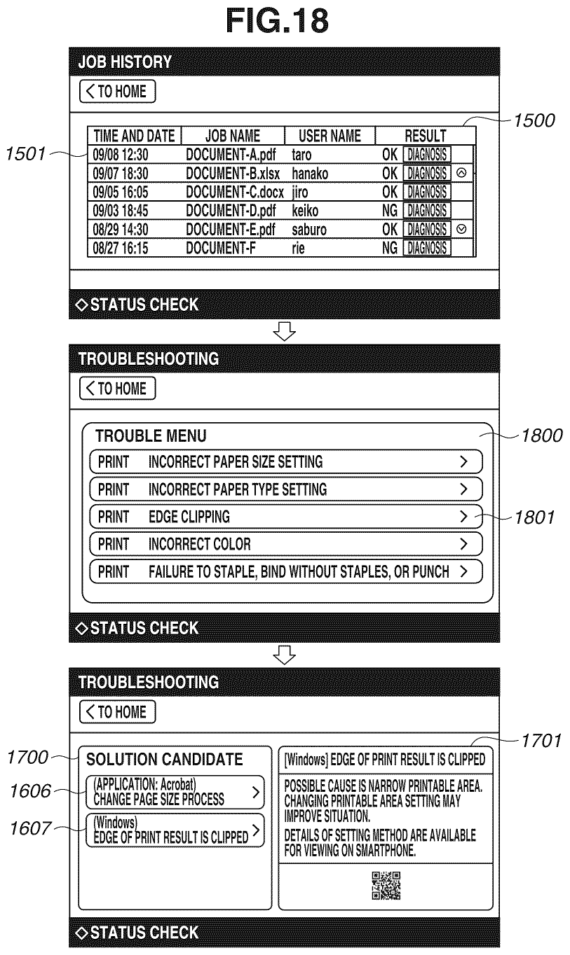

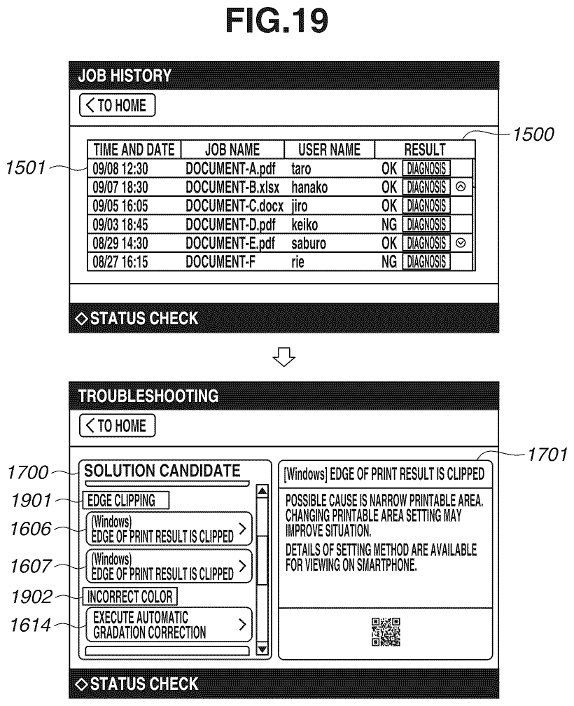

Further, while an example of solution candidate extraction by comparing with all the solutions in the solution list 1600 in a case where the job 1501 is selected is described, this is merely an example and not a limitation. For example, in a case where the job 1501 is selected, first, the candidate job extraction table 800 may be looked up in reverse to extract related troubleshooting information, and thereafter only the solution related to the issue from the solution list 1600 may be compared. Furthermore, regarding the display, after the job 1501 is selected, a trouble menu 1800 related to the job 1501 may be displayed, and after an issue 1801 to be troubleshooted is selected, solutions may be displayed, as illustrated in FIG. 18. Further, related issues and corresponding solutions may be displayed on a single screen after the job 1501 is selected, as illustrated in FIG. 19. An example in which solutions 1606 and 1607 corresponding to an issue 1901 and a solution 1614 corresponding to an issue 1902 are displayed is illustrated here.

While a method of refining solution candidates based on a job selected from a job history without selecting troubleshooting information is described above, the solution candidates may be prioritized rather than refined, and the display order may be changed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-051065, filed Mar. 27, 2024, which is hereby incorporated by reference herein in its entirety.

What is claimed is:

1. An information processing apparatus with a job execution function, the information processing apparatus comprising:
a first acceptance unit configured to accept selection of troubleshooting information;
a display control unit configured to display job information about one or more executed jobs in a display section of the information processing apparatus;
a second acceptance unit configured to accept selection of one or more pieces of job information from the displayed job information; and
a troubleshooting unit configured to perform troubleshooting on the information processing apparatus based on the selected troubleshooting information and the selected job information,
wherein the display control unit displays a result of the troubleshooting in the display section.

2. The information processing apparatus according to claim 1, further comprising an operation unit including the display section.

3. The information processing apparatus according to claim 1, further comprising:
a printer having a print function; and
a reception unit configured to receive a print job to be printed by the print function from an external apparatus,
wherein the information processing apparatus executes the print job received by the reception unit using the print function.

4. The information processing apparatus according to claim 3, wherein in a case where the second acceptance unit accepts selection of job information about the print job, the troubleshooting unit performs troubleshooting on the information processing apparatus using information about the print function further.

5. The information processing apparatus according to claim 1, further comprising:
a reading device configured to read an original image; and
a transmission unit configured to transmit image data generated by the reading device through reading to an external apparatus,
wherein the information processing apparatus executes a transmission job to transmit the image data generated by the reading device through reading to the external apparatus using the transmission unit.

6. The information processing apparatus according to claim 5, wherein in a case where the second acceptance unit accepts selection of job information about the transmission job, the troubleshooting unit performs troubleshooting on the information processing apparatus using information about the transmission unit further.

7. The information processing apparatus according to claim 1, wherein the display control unit displays the troubleshooting result related to the troubleshooting information.

8. The information processing apparatus according to claim 1, wherein the display control unit displays the troubleshooting result related to the job information.

9. The information processing apparatus according to claim 1, wherein the display control unit displays the troubleshooting result related to the troubleshooting information and the job information.

10. The information processing apparatus according to claim 1, wherein the display control unit displays a quick response (QR) code to provide additional information corresponding to the troubleshooting result in the display section.

11. A method for controlling an information processing apparatus, the method comprising:
executing one or more jobs;
accepting selection of troubleshooting information;
displaying job information about one or more executed jobs in a display section of the information processing apparatus;
accepting selection of one or more pieces of job information from the displayed job information;
performing troubleshooting on the information processing apparatus based on the selected troubleshooting information and the selected job information; and
displaying a result of the troubleshooting in the display section.

12. A non-transitory computer-readable storage medium on which is stored a computer program for making a computer execute a method for an information processing apparatus, the method comprising:
executing one or more jobs;
accepting selection of troubleshooting information;
displaying job information about one or more executed jobs in a display section of the information processing apparatus;
accepting selection of one or more pieces of job information from the displayed job information;
performing troubleshooting on the information processing apparatus based on the selected troubleshooting information and the selected job information; and
displaying a result of the troubleshooting in the display section.
